(19) United States
(12) Patent Application Publication
(10) Pub. No.: US 2010/0004924 A1
(43) Pub. Date: Jan. 7, 2010

(54) Method and system context-aware for identifying, activating and executing software that best respond to user requests generated in natural language

(76) Inventor: Yuri Luis Paez, Zapopan (MX)

Correspondence Address: Yuri Paez, Lince Oriente # 217, Cd. Bugambilias, Zapopan, Jalisco, 45237, omitted

(21) Appl. No.: 12/167,247

(22) Filed: Jul. 3, 2008

(51) Int. Cl. G06F 17/27

(52) U.S. Cl. 704/9

(57) ABSTRACT

A computer-implemented method capable of identifying, activating, and executing commands, methods, functions, interfaces, and software-based applications that can satisfy a specific natural language user request represented by a text stream and generated from any means such as typing, voice, gestures, signs or by human thoughts.

### BRIEF DESCRIPTION OF THE DRAWINGS

FIG. 1: Invention overview diagram.

FIG. 2: Flow diagram describing the process to get the user request.

FIG. 3: Proposed main user interface.

FIG. 4: Flow diagram describing the process to identify the context.

FIG. 5: Context levels.

FIG. 6: Flow diagram describing the process to identify the verb and objects.

FIG. 7: Proposed user interfaces to register contexts, interfaces, and solutions for the computer-implemented method.

FIG. 8: XML Schema to define relations between contexts, interfaces, solutions, verbs, objects and keywords.

FIG. 9: Flow diagram describing the process to create and display the possible solutions to the user request.

FIG. 10: Proposed user interfaces to show the result list of solutions.

FIG. 11: Flow diagram describing the process to execute the solution selected by the user.

FIG. 12: Flow diagram describing the process to register a possible solution.

### DESCRIPTION

### TECHNICAL FIELD

This invention is related with computer-based systems, specifically with the software in such systems and the manner in which this software is used and accessed by the users.

### BACKGROUND OF THE INVENTION

Currently there are a considerable number of software applications addressing different user needs. Most of them are executed over specific operating systems using their different services. Operating system developers have tried to simplify the interactions between software applications and users by offering command-based interfaces, graphical user interfaces such as icons, menus, contextual menus and so others.

However, current interfaces are still complex even for experienced users. In addition, user interfaces are so inflexible in a way that they constraint the capabilities of what can user do with the software-based applications. The reason behind this limitation is identified in the low level granularity of such interface commands where the commands are not able to represent high level user requests. This situation forces the user to learn a fixed manner to interact with the software applications in order to get the results that users expected to obtain. Sometimes, this problem just starts when the user needs to select the correct application to get some specific result.

For example, if the user wants to send an electronic mail then, he needs to know which application handles the email operations or which web address has the corresponding services addressing email. This situation implies the user should have a previous knowledge about the applications and their corresponding functions. The invention described in this document proposed a new method to interact with software-based applications and the services that they provide. This invention generates a set of potential solutions for user requests focusing on software functionalities and allowing the user to execute the solution he considers satisfies his request with the additional advantage that the communication can be performed using natural language.

### SUMMARY OF THE INVENTION

The goal of this invention is to provide a computer-implemented method to analyze the user requests generated by different means (voice, typed, gestures, or thoughts) and to find the software functionality which better satisfies the user request. The method implementation is able to identify the request context, verbs, objects, and keywords. Then, the method implementation searches the best matches in the repository that relates applications, methods, scripts, commands, interfaces, or software component with contexts, verbs (and their synonyms and alias), objects (and their synonyms and alias) and keywords. Next, the method implementation displays a list of matches and activates or executes the software related with the user selection or the default solution.

### DETAILED DESCRIPTION OF THE INVENTION

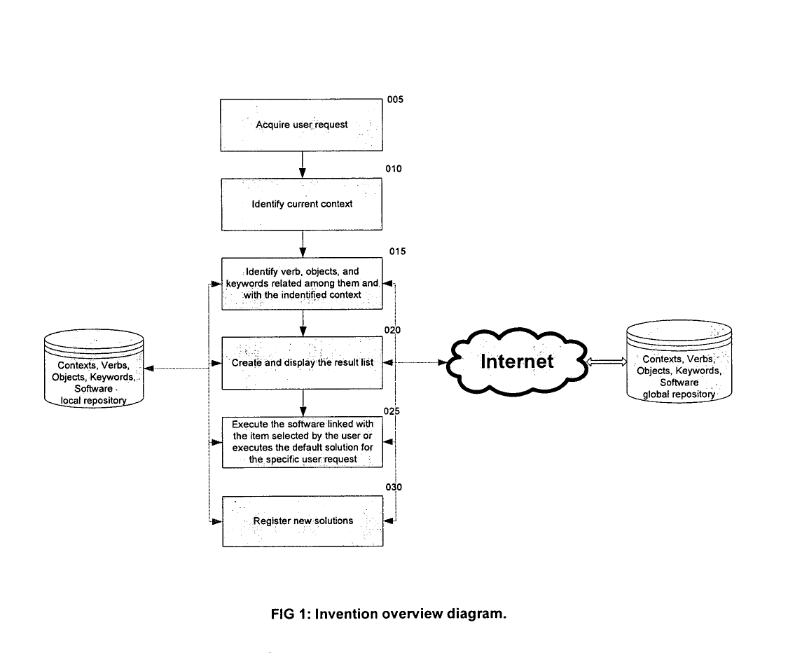

FIG. 1 shows the diagram overview for this invention. This diagram presents the main processes for identifying the commands, methods, interfaces, applications, and any software that can be used to response a specific user request generated by natural language.

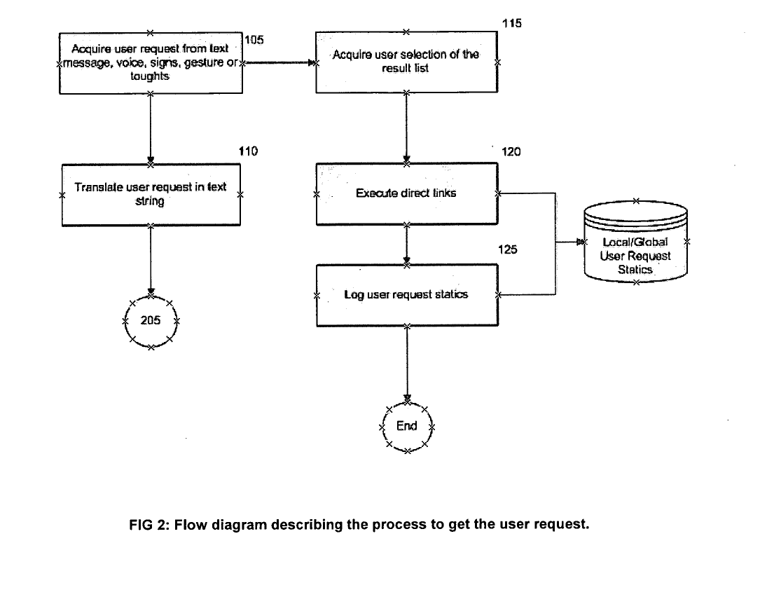

The “Acquire user request” 005 process is shown in FIG. 2. This process starts with the sub process “Acquire user request from text message, voice, signs, gesture or thoughts” 105. This sub process captures the user request by using devices, drivers, operating system and/or specialized software to capture user request generated by a typed message, voice, gestures, signs, or thoughts for being transformed into a natural language text stream.

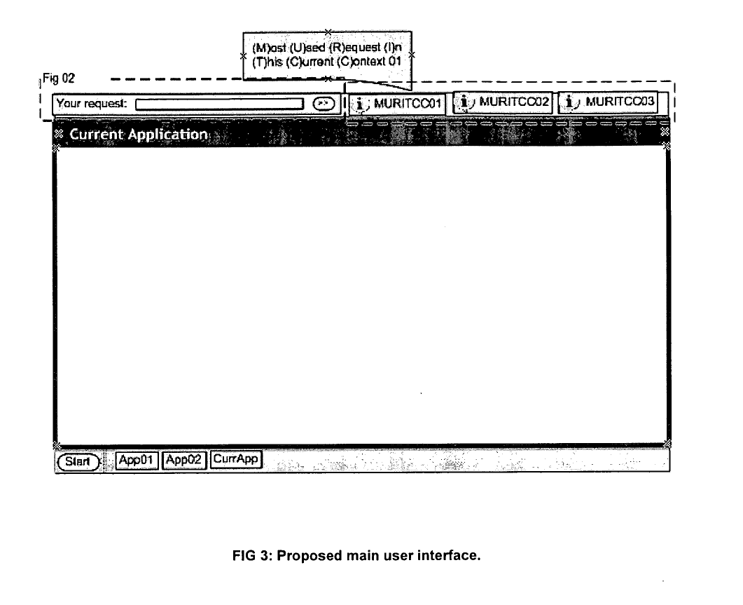

We will use an example to illustrate the processes described in this invention by using the most popular devices used to capture user request such as keyboard, mouse, and monitor. The user request example is described by the next user request: “Send this document to George” where the request is generated by the mentioned devices using an interface similar to the one described in FIG. 3. This interface uses the text typed by the user and then, the sub process “Translate text string user request” 110

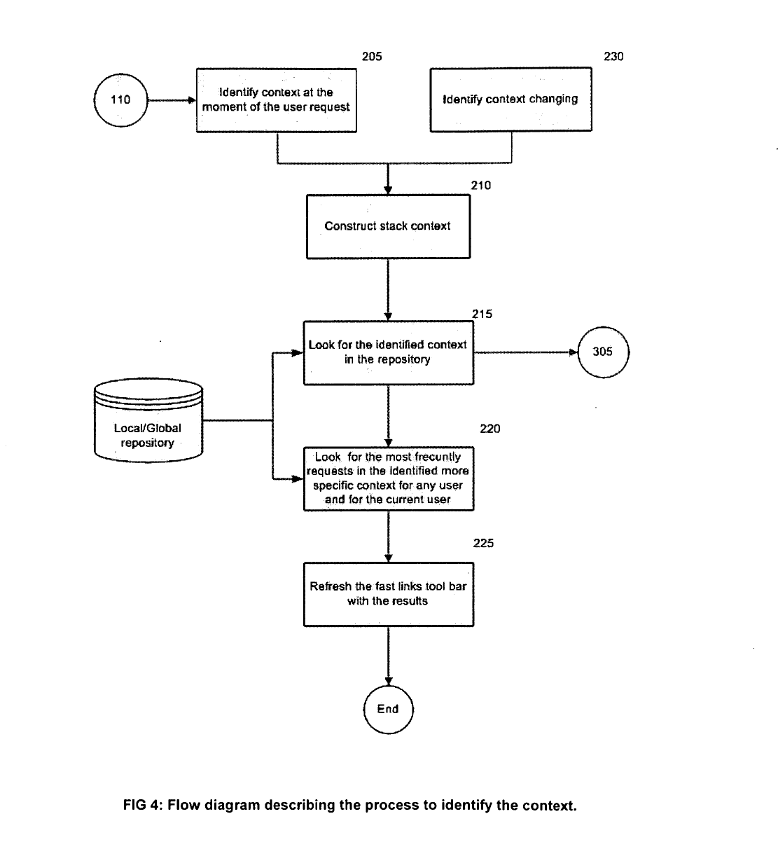

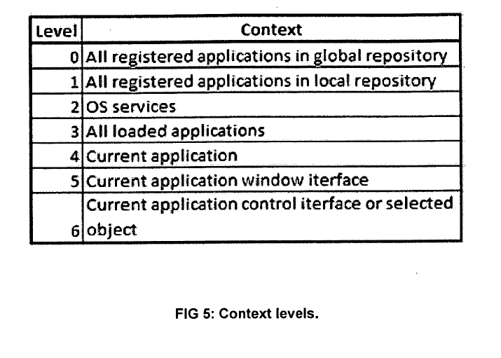

The flow continues with the process “Identify current context” 010 shown in FIG. 4. It starts with “Identify context at the moment of the user request” 205 sub process. A definition for the term “context” in this invention is provided as follows: A context represents a set of applications, services, software or interfaces that are activated or are potentially related with the user request at the specific time of the request. The sub process “Construct stack context” 210 builds an stack structure with the different levels of active or registered contexts at the time of the request. FIG. 5 shows a graphical representation of the Context Stack Levels. The stack starts at level zero where a set of applications is registered in a global repository such as an internet-based database server. Next, level 1 focuses on those applications located in a local repository. Following, level 2 contains all services provided by the operating system. Level 3 includes the active or currently loaded applications. Finally, level 4 to 6 includes information for a specific application, interface, or selected object.

Using the same example where the user requests to send a document to some person and the user is working with a word processor to edit his document. In this case, the system is capable of identifying this context using some basic functions in the operating system, where level 5—Current Application—is bound to the “WinWord Application”, level 6—Current application window interface—is bound to “Meeting Minute—Word Processor”, and the last level in the stack is blank since there is no specific control in the window interface for this example.

The next sub process, “Look for the identified context in the repository” 215, the system looks for the most adequate context by searching cyclically o recursively starting from the context more specific (Level 6) up to the most generic context (Level 0). Using the example presented previously, the searching using the control within the interface (Level 6) does not provide any valuable information; then the search continues in the next level, using the current application interface window “Meeting Minute.doc—Word Processor” where the context (“Word Processor”) can be extracted from this title and found in the repository.

Generally, the software applications have functionalities that are used more frequently than others. Then, it is necessary to increase the usability from repeatedly user request by overcoming the problems related with the potential delay or overhead generated in repeatedly user interactions. The method implementation provides a graphical user interface similar to the shown in FIG. 3 which is used by the user as common interactive interface. This interface will start the sub process “Acquire user selection by the visual software interface” 115 where the user is able to select one of the direct links representing the most common solutions for the user request. After the user selects a direct link, the sub process “Execute direct links” 120 is activated. This sub process activates or executes the corresponding software application or set of applications related with the solution selected. At the same time of this execution, the process “Log user request statistics” 125, 530 collects the information from the user selected link. This updated information is used for determining changing in the context by the process “Identify context changing” 230 which calls the process “Refresh the fast links tool bar with the results” 225 using the statistical information generated by the user or the global repository associated to specific context. The determination of the most frequent request identified for a context is achieved by the process “Look for the most frequently requests in the identified more specific context for any user and for the current user” 220.

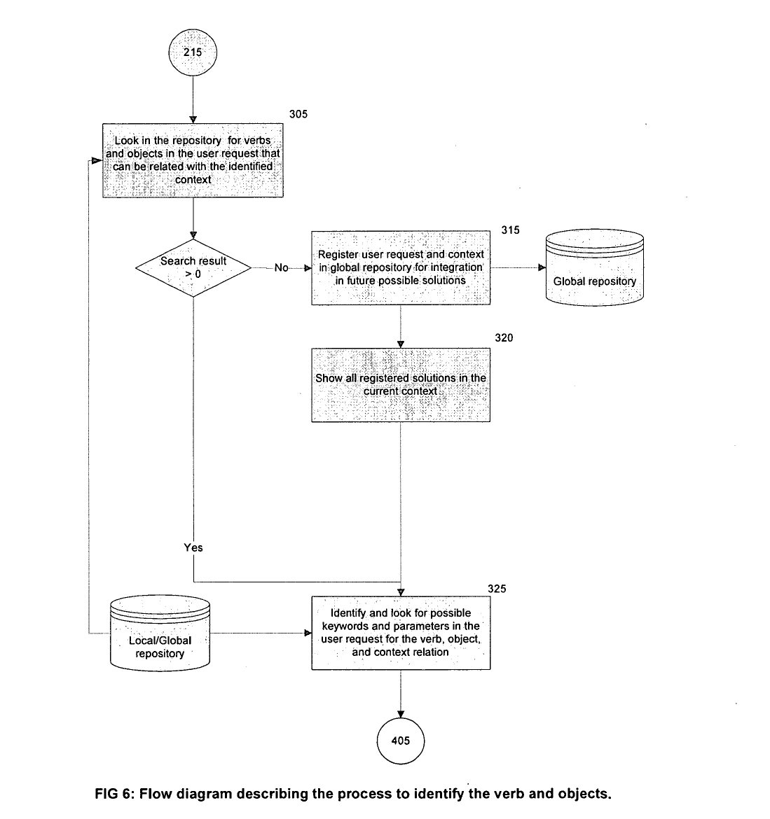

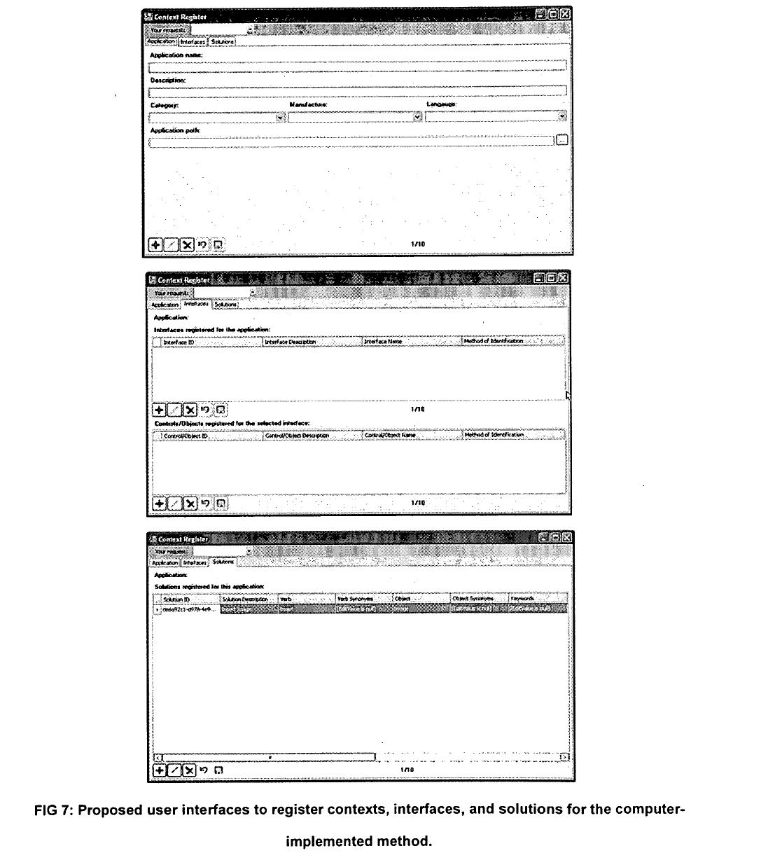

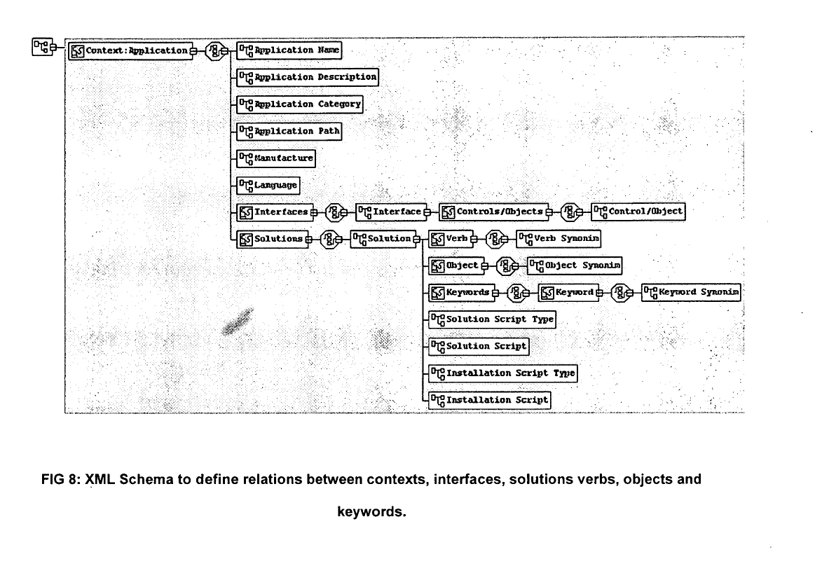

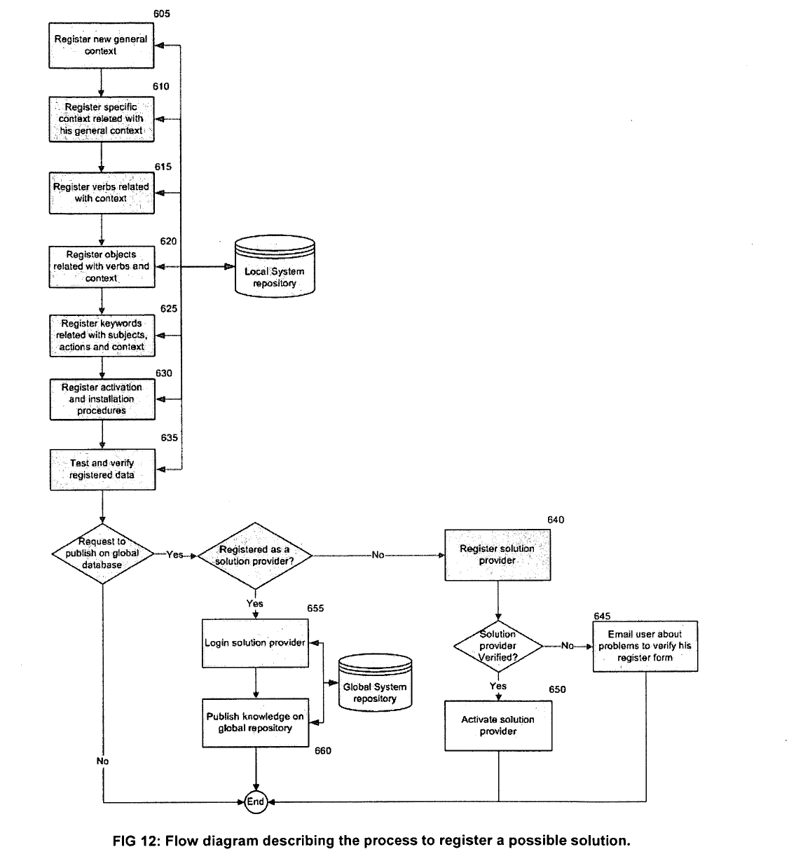

After the context had being identified, the method implementation starts the process “Identify verb, objects, and keywords related among themselves and with the indentified context” 015 as shown in FIG. 6. The process starts by calling the sub process “Look in the repository for verbs and objects in the user request that can be related with the identified context” 305 where the method implementation uses the words found in the user request and it determines the key elements, such as verb and objects. Using the previous example about the word processor, the verbs, objects, and means to activate the software may be provided by the software provider or by third party providers. To achieve such purpose,.this invention uses an interface similar to the one presented in FIG. 7 or by using any text-based models such as the XML schema shown in FIG. 8. The process to associate and register solutions with context, software applications, interfaces, verbs, objects, and keywords is presented in FIG. 12.

The success of any request based on unique words using natural language can limit the applicability and usage of the method implementation. To overcome this limitation, this invention proposes to define synonyms or alias to map the same concept using different words. The use of synonyms or alias is allowed to any entity in the system including objects, verbs, keywords, or contexts.

Additionally, it is also possible to define prefixes or suffixes associated to each context, verb, object, or keyword to reduce the potential mismatch for cases such as verbs and their conjugations. Using the previous example, “Send this document to George”, the system identified distinct keywords: the word “Send” is identified as a verb in the repository. Additionally, the repository may have registered as synonyms of the word “send”: “transfer” or “deliver”.

In the case that any word is not found in the actual context, the method implementation looks for a match in higher or more general contexts trying to find a solution associated to the verb or object included in the user request.

Once the context and verb has been identified, the method implementation continues to identify the object associated to the context and the verb. In the example, the identified object is “this document”. Depending on the language used in the method implementation, it is possible to define keywords with more than one word. In the example, “this document” represents the registered object in the context of the Word Processor application. It is important to notice that the response generation capability is determined by the capabilities of the software applications which are registered in the repository. Therefore, the best response accuracy is determined by the extent of the repository information about the application functionalities and the way that these functionalities could be invoked or referenced by contexts, verbs, objects, keywords and their synonyms.

Even when this method cannot solve all possible user requests, it has the capability of feeding the local or global repository with requests not solved, as it is shown in the sub process “Register user request and context in global repository for integration in future possible solutions” 315. The method implementation shows a set of all possible registered solutions by executing the sub process “Show all registered solutions in the current context” 320, this gives to the user the possibility to query all possible solutions registered for the current context.

Once the object is identified in the request, the next sub process starts: “Identify and look for possible keywords and parameters in the user request for the verb, object, and context relation” 325. This sub process identifies the keywords required by the context, verb, and object which are previously registered in the repository which improves the accuracy in the solution. A parameter is a word or list of words that appear next to a keyword to improve the accuracy in the request. Using our example, “George” is the parameter for the keyword “to”. Parameters are not registered words in the repository. They are similar to the programming language variables where they may take any value in different execution times. Additionally, the method implementation might determine that the target “George” is ambiguous since the method implementation does not know if “George” is a contact in the local address book or a contact in a global address book. The method implementation scope is limited by the amount of information that can be deterministically associated. In this case, the method implementation is able to launch the email client and to enable everything before sending the email until the user confirms that “George” is the correct target.

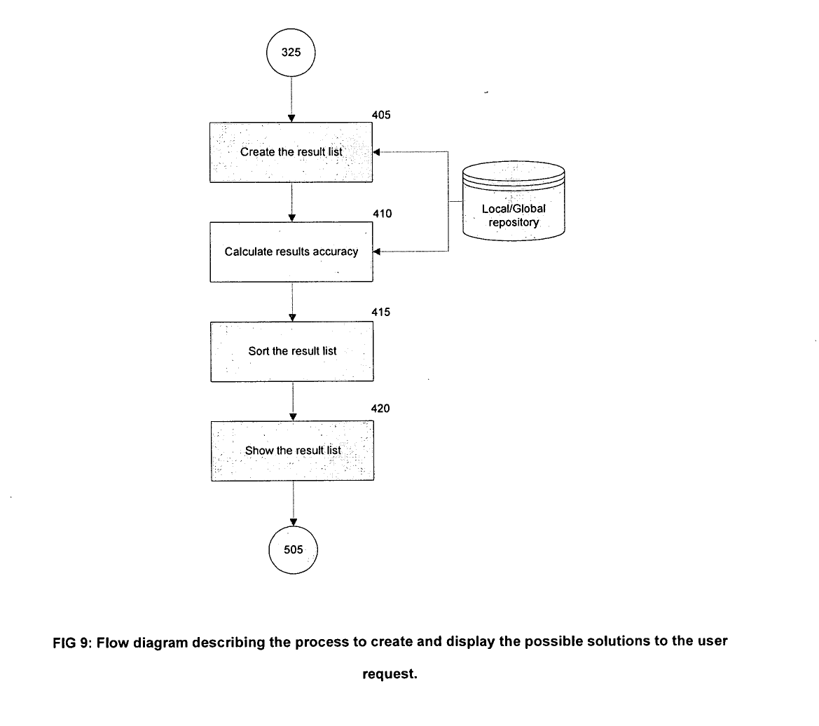

The next process in the flow is “Create and show the result list” 020 which is shown in FIG. 9. This process starts with “Create the result list” 405 sub process, which generates a list of possible answers from the relationships found in the repository Context→Verb→Object→Keywords from the words found in the user request.

The method implementation assess the accuracy of the results by executing the process “Calculate result accuracy” 410 where an accuracy index is calculated for each result. This result is obtained from combining numerical information from the identified contexts and the matching words found in the user request by searching in the repository data. For each context, a sum is computed depending on the matching type. The corresponding weights are defined as follows:

For a specific context, the weights associated to the specific matches are:

Words identified as object in the specific context but no verb is found: 60

Words identified as verb but no object is identified in the specific context: 70

Words identified as verb and object in the specific context: 90

All words in the request were identified: Add 10

In this case, the maximum sum that can be obtained is 100 and the minimum useful sum is 60.

For cases where the solution is not found in the specific context, the corresponding sum for solutions found in different levels in the stack context is reduced in the 1/L % for each stack level, where L is the number of levels in the stack.

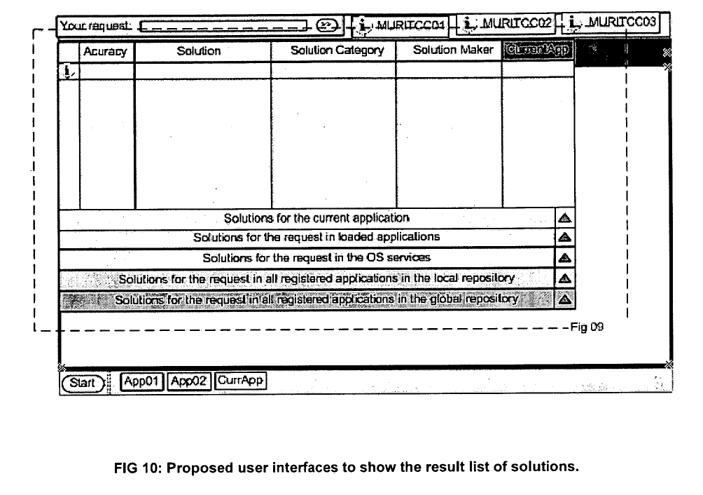

After computing the accuracy index for each result found in the list, the system sorts the list using this index as reference by executing the sub process “Sort the result list” 415. The results are shown in an interface similarly to the FIG. 10 using the sub process “Show the result list” 420.

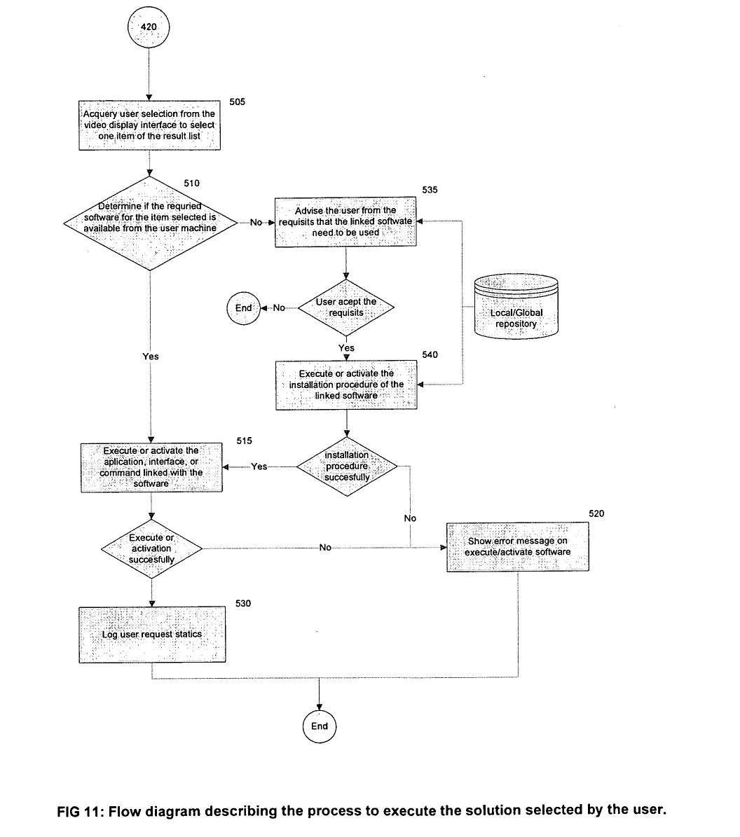

The next process in the flow is “Execute the software linked with the item selected by the user or executes the default solution for the specific user request” 025, shown in FIG. 11. This process starts with the sub process “Acquire user selection of the result list” 505. This sub process waits for the user action to select any option in the list or directly execute the default solution if the accurate index calculated for this is the highest in the list. Next, the sub process “Determine if the required software for the item selected is available in the user machine” 510 where the implemented method verifies if the software components required for the solution selected are installed in the machine. This might be done by using operating system services.

If the software application requires any user authorization for being executed, any payment, or any installation then, the method implementation warns the user by executing the sub process “Advise the user from the requisites that the linked software need to be used” 535. If the user accepts the requisites, then the system executes the sub process “Execute or activate the installation procedure of the linked software” 540 based on the information registered in the repository.

Next, the method implementation executes the sub process “Execute or activate the application, interface, or command linked with the software” 515. This process uses the activation definition registered in the repository for the user selection. The activation definition can be created by the software application providers or third party vendors who can wrap the applications by other software applications. The activation methods may vary depending on the services provided by the operating systems and the corresponding activating applications. The activation can be a simple keystroke sequence, an operating system command sequence, a web page link, web service invocation, the application execution, or any other method to invoke an application.

If an error is found during the solution installation, execution or activation, then it's “Show error message on execute/activate software” 520; Otherwise the flows goes to the sub process “Log user request statics” 530 which register the statics for the user request, context and the selected solution. Finally the method implementation concludes the execution by transferring the control to the activated application and waiting for another user request.

The registering of new solutions is achieved by executing the process “Register new solutions” 030 shown in FIG. 12. This process starts the “Register new general context” 605 sub process where the general context is registered unless it has been previously registered. If this is the case, then the user just needs to select the general context from a list. Next, the sub process “Register specific context related with its general context” 610 registers the specific context associated with the general context. The mechanism defined for the cases where a general context exists previously is similarly handled for specific contexts.

The next sub process, “Register verbs related with context” 615, allows to add actions and to associate them with the registered contexts defined in the previous sub processes (605 and 610). In this sub process the synonym associations and prefix definitions can be also defined. Following, the sub process “Register objects related with verbs and context” 620, registers the objects associated to all items previously defined as well as synonyms and prefixes. The sub process, “Register keywords related with objects, verbs, and context” 625, can be considered optional if the relations between context, verb, and object do not require them. Since parameters can be presented in considerable different formats, the parameter definition is determined by the keyword that defines or identifies them. For example, the request “Print pages from 5 to 7”, in the Word Processor context, can have keywords to identify parameters such as the keywords “from” and “to” and the parameters “5” and “7”.

The process “Register activation and installation procedures” 630 defines the procedures to activate or install the required software. The intention is that these procedures do not require manual interaction (i.e., having automatic procedures as possible). However, the degree of automation will rely on the people who register the application and the functionalities provided by the software applications. The activation of applications is based and constrained by the mechanism provided by the operating system such as keystroke sending, script execution, method invocation, etc. The result of this execution should satisfy the user request or provide a user interface to guide the execution.

The next sub process “Test and verify registered data” 635 focuses on testing all information from one user request and its corresponding solutions in the host where the request is performed and the information is recorded with the possibility of registering the request and solution in the global repository. The global repository registration can only be performed if the solution provider is previously recorded in the global repository and the information has been verified, as it is shown in the sub process “Register solution provider” 640. The verification plays an important role since it reduces the risks for unsafe solution that may damage the host information integrity. If the information verification corroborates the authenticity, the sub process “Activate solution provider” 650 is performed. During this process, a security key is sent to the solution provider to record the solution in the global repository. If the information from the solution provider cannot be verified, the sub process “Email user about problems to verify his register form” 645 is performed.

If the solution provider is already registered and previously verified, the solution provider can access the global repository with a security key. These tasks are performed by the sub process “Login solution provider” 655. After the successful accessing into the system, the provider can publish new solutions in the global repository by performing the sub process “Publish knowledge on global repository” 660. This publication might be implemented by using web services or related technologies.

What is claimed is:

1) A computer-implemented method for identifying commands, functions, interfaces, and software-based applications that can satisfy a specific user request generated by any mean such as typing, voice, gestures, signs or by human thoughts which can be translated into a natural language text stream. The method comprises: identifying the context from where the request take place; identifying the verb, object and keywords from the text stream which contains the user request expressed in natural language; searching for the software applications or functionalities associated to the context, verbs, objects, and keywords and their synonyms or alias into the repository; looking for a solution or a set of matches solutions for the user request; and activating or executing the solution selected by the user if necessary.

2) The method of claim 1, wherein using an universal database of associations relating software, applications, systems, software modules, components, libraries, commands and interfaces with contexts, verbs, objects, keywords and their synonyms or alias.

3) The method of claim 1, wherein the method is implemented as part of an operating system.

4) The method of claim 1, wherein the method is implemented as part of an software application.

5) The method of claim 1, wherein the method is implemented as part of a voice-recognition, gesture-recognition, thought-recognition, text-based, or graphical user interface.

6) The method of claim 1, wherein the method is implemented as a software component.

7) The method of claim 1, wherein the method is implemented as a part of an Internet Browser.

8) The method of claim 1, wherein the method is implemented as a part of a Web application.

9) The method of claim 1, wherein the method is implemented as a part of a Web site or any of its components.

10) The method of claim 1, wherein the method is implemented as a part of a mobile device.

11) The method of claim 1, that's implements a dynamic context tool bar based on the statics of the requests made by the user or users.
